(19) United States
(12) Patent Application Publication
(10) Pub. No.: US 2024/0420022 A1
(43) Pub. Date: Dec. 19, 2024

(54) SYSTEMS AND METHODS FOR PREDICTING A SET OF PROBABLE CLASSES FOR TEST DATA

(71) Applicant: Samsung Electronics Co., Ltd., Suwon-si (KR)

(72) Inventors: Ritesh SINGH, Uttar Pradesh (IN); Kalgesh SINGH, Uttar Pradesh (IN); Mohd Amir ANSARI, Uttar Pradesh (IN)

(21) Appl. No.: 18/582,246

(22) Filed: Feb. 20, 2024

Related U.S. Application Data
(63) Continuation of application No. PCT/KR2024/000941, filed on Jan. 19, 2024.

(30) Foreign Application Priority Data
Jun. 16, 2023 (IN) 202311041159

(51) Int. Cl. G06N 20/00

(52) U.S. Cl. CPC G06N 20/00

(57) ABSTRACT

A system and method for predicting a set of probable classes for test data is described. The method comprises retrieving, from a memory a training dataset, a plurality of classes, and a plurality of corresponding training feature vectors for each of the plurality of classes. The method comprises receiving an input indicative of a target probability required for the test data. The method comprises determining a set of membership probabilities for the test data that include a corresponding membership probability associated with each of the plurality of classes, the corresponding membership probability being indicative of a probability of the test data belonging to a corresponding class of the plurality of classes. The method comprises determining, based on the input and the set of membership probabilities, the set of probable classes, from the plurality of classes, for the test data.

### CROSS-REFERENCE TO RELATED APPLICATIONS

This application is a continuation of International Application No. PCT/KR2024/000941 designating the United States, filed on Jan. 19, 2024, in the Korean Intellectual Property Receiving Office and claiming priority to Indian patent application Ser. No. 20/231,1041159, filed on Jun. 16, 2023, in the Indian Patent Office, the disclosures of each of which are incorporated by reference herein in their entireties.

### BACKGROUND

### Field

The disclosure relates to the field of data classification. For example, the disclosure relates to methods and systems for predicting a set of probable classes for test data based on a target probability of classification required by a user.

### Description of Related Art

Classification is a fundamental concept in Machine Learning (ML) applications. Classification involves grouping of data into predefined classes or categories. Classification is a supervised ML method where an ML model tries to predict a correct class for given input data. For proper classification, the ML model may be trained using predetermined training data. Further, the ML model may be evaluated based on training data and/or test data before being deployed to perform prediction on real-time data. Thus, the ML model may learn patterns and relationships from the training data to perform successful predictions and/or classification of the real-time data. Some classification algorithms utilize techniques such as decision trees, support vector machines, logistic regression, and neural networks.

### SUMMARY

According to an example embodiment of the present disclosure, a method for predicting a set of probable classes for test data is disclosed. The method comprises retrieving, from a memory comprising a training dataset, a plurality of classes, and a plurality of corresponding training feature vectors for each of the plurality of classes. The method comprises receiving an input indicative of a target probability required for the test data. The method comprises determining a set of membership probabilities for the test data. The set of membership probabilities comprises a corresponding membership probability associated with each of the plurality of classes. The corresponding membership probability is indicative of a probability of the test data belonging to a corresponding class of the plurality of classes. The method comprises determining, based on the input and the set of membership probabilities, the set of probable classes, from the plurality of classes, for the test data.

According to an example embodiment of the present disclosure, a system for predicting a set of probable classes for test data is disclosed. The system comprises a memory and at least one processor, comprising processing circuitry, communicatively coupled to the memory. At least one processor, individually and/or collectively, configured to retrieve, from a memory comprising a training dataset, a plurality of classes, and a plurality of corresponding training feature vectors for each of the plurality of classes. At least one processor, individually and/or collectively, configured to receive an input indicative of a target probability required for the test data. At least one processor, individually and/or collectively, configured to determine a set of membership probabilities for the test data. The set of membership probabilities comprises a corresponding membership probability associated with each of the plurality of classes. The corresponding membership probability is indicative of a probability of the test data belonging to a corresponding class of the plurality of classes. At least one processor, individually and/or collectively, configured to determine, based on the input and the set of membership probabilities, the set of probable classes, from the plurality of classes, for the test data.

To further clarify the advantages and features of the present disclosure, a more detailed description of the disclosure will be rendered by reference to various example embodiments thereof, which are illustrated in the appended drawings. It is appreciated that these drawings merely depict example embodiments and are therefore not to be considered limiting of the scope of the disclosure. The disclosure will be described and explained with additional specificity and detail with reference to the accompanying drawings.

### BRIEF DESCRIPTION OF THE DRAWINGS

These and other features, aspects, features and advantages of certain embodiments of the present disclosure will be more apparent from the following detailed description, taken in conjunction with the accompanying drawings in which like characters represent like parts throughout the drawings, and in which:

FIG. 1A is a diagram illustrating a schematic of a feature space and training data corresponding to an ML model, in accordance with the prior art;

FIGS. 1B, 1C, 1D, 1E, 1F and 1G are diagrams illustrating various example use case scenarios where a classifier may misclassify input data, in accordance with one or more techniques of the prior art;

FIG. 2 is a block diagram illustrating an example environment for predicting a set of probable classes for test data; according to various embodiments;

FIG. 3 is a block diagrams illustrating an example configuration of a user device and system for predicting the set of probable classes for the test data, according to various embodiments;

FIG. 4 is a block diagram illustrating an example configuration of one or more modules of the system for predicting the set of probable classes for the test data, according to various embodiments;

FIGS. 5, 6A, 6B, 7, 8, 9 and 10 are diagrams illustrating example use cases for predicting the set of probable classes by the system, according to various embodiments; and

FIGS. 11A, 11B and 11C are flowcharts illustrating example methods for predicting the set of probable classes for the test data, according to various embodiments.

Further, skilled artisans will appreciate that elements in the drawings are illustrated for simplicity and may not have necessarily been drawn to scale. For example, the flowcharts illustrate methods in terms of steps involved to help to improve understanding of aspects of the present disclosure. Furthermore, in terms of the construction of the device, one or more components of the device may have been represented in the drawings by conventional symbols, and the drawings may show those specific details that are pertinent to understanding embodiments of the present disclosure so as not to obscure the drawings with details that will be readily apparent to those of ordinary skill in the art having the benefit of the description herein.

### DETAILED DESCRIPTION

Reference will now be made to the various example embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory and are not intended to be restrictive.

Reference throughout this specification to “an aspect”, “another aspect” or similar language may refer, for example, to a particular feature, structure, or characteristic described in connection with the embodiment being included in at least one embodiment of the present disclosure. Thus, appearances of the phrase “in an embodiment”, “in another embodiment” and similar language throughout this disclosure may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The present disclosure relates to a method and a system for predicting a set of probable classes for test data given a target probability desired by a user. The method includes utilizing user input indicative of a target probability required for the test data to predict the set of probable classes. Thus, instead of providing wrong output due to misclassification, the disclosed method provides a set of output to enable a user to view probable options, and further, select the most relevant result as per user's requirement.

Misclassification is a major problem associated with ML models using classification algorithms. Despite the significant advancements in the classification algorithms, misclassification remains a critical challenge in ML applications. For an ML model, a misclassification rate is a metric related to a percentage of observations that are incorrectly predicted by the ML model. The misclassification rate may be determined based on a number of incorrect predictions out of a total number of predictions. The misclassification occurs when the ML model incorrectly assigns data to a class, leading to erroneous predictions and potentially undesirable consequences.

In various classification techniques, a set of hyper-planes may be identified to classify different types of data. However, it may not be possible to identify a hyperplane that completely segregates the associated data points, thus causing errors in classification as some points may be wrongly classified while some points may be missed.

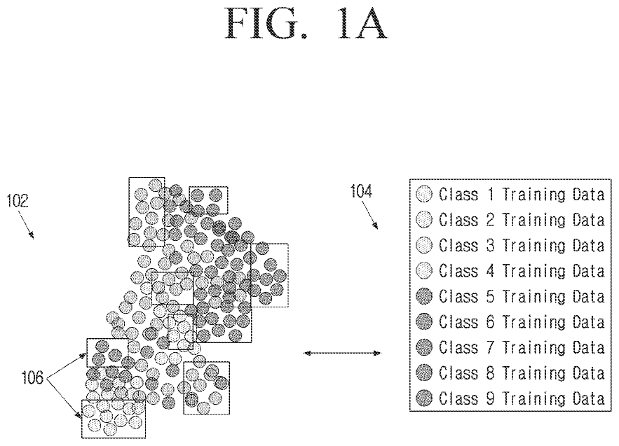

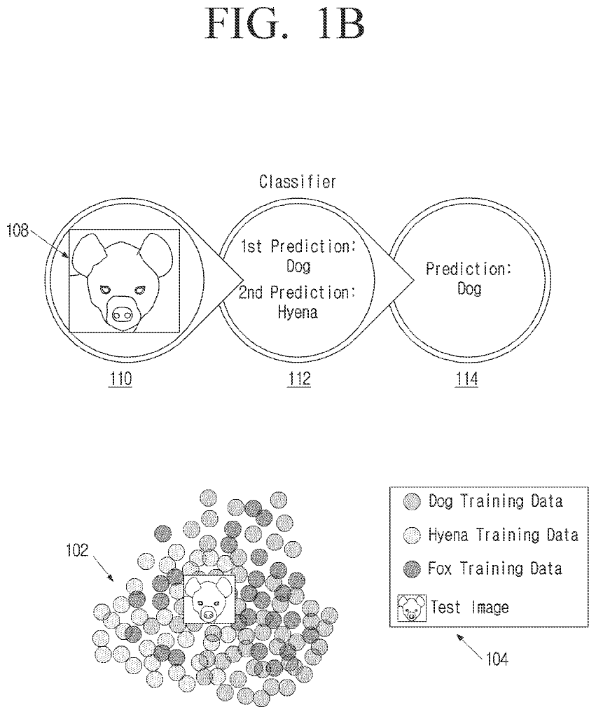

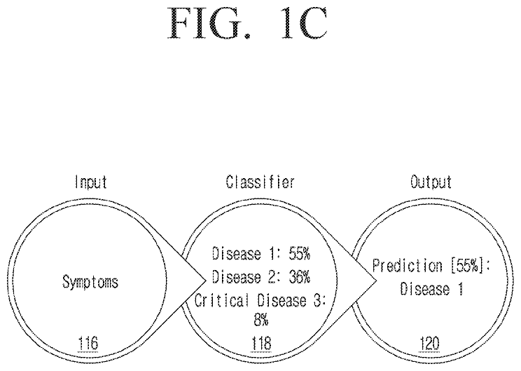

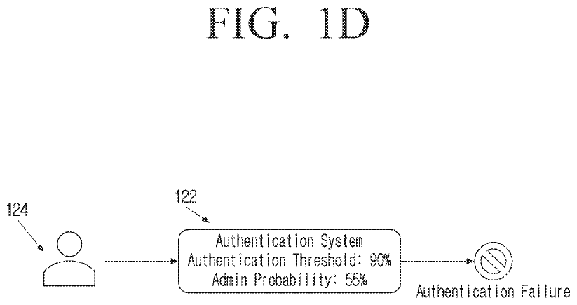

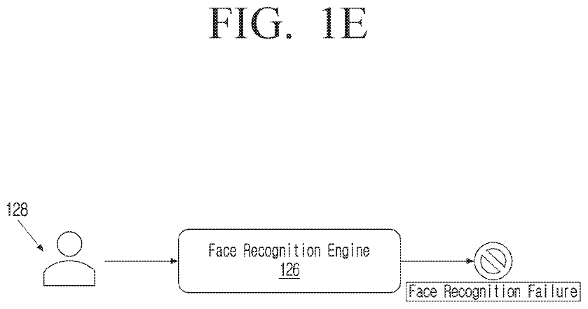

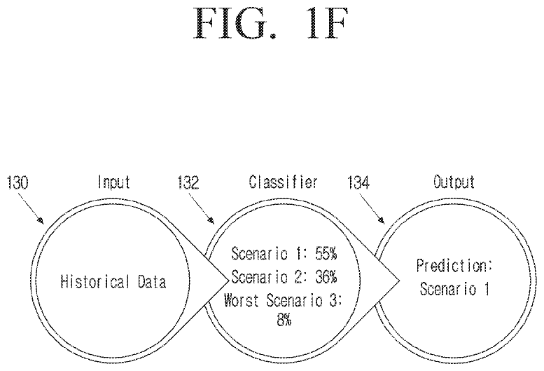

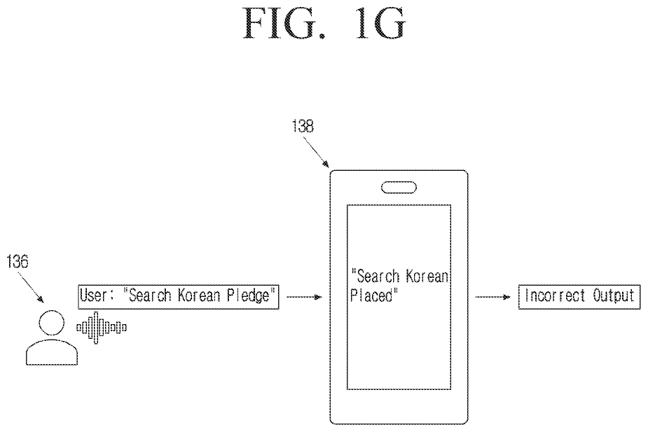

In most real-world problems, the training data associated with the ML model is not separated cleanly. FIG. 1A is a diagram illustrating a feature space 102 and training data 104 corresponding to an ML model. The training data 104 may be associated with different classes. As shown in FIG. 1A, large portions of the feature space 102 are zones of misclassification where the training data 104 overlaps with each other. Zones within bounding boxes 106 may be considered as zones of accurate classification while zones outside of the bounding boxes 106 may be considered as zones of misclassification.

FIG. 1B is a diagram illustrating an example use case scenario where a classifier (an ML model) may misclassify input data. The input data may be a test image. The training data 104 may be provided to the classifier, the training data comprising dog training data, hyena training data, and fox training data. Initially, a test image 108 of a hyena may be received by the classifier, at block 110. Within the feature space 102, the test image 108 may overlap with different training data, as shown in FIG. 1B. At block 112, the classifier may predict that the test data matches a dog more strongly than a hyena, and at block 114, the classifier may incorrectly provide the output classification as a dog.

FIG. 1C is a diagram illustrating another example use case scenario where the classifier may misclassify input data. As seen in FIG. 1C, symptoms for a disease may be provided as input data to the classifier, at block 116. At block 118, the classifier may predict that symptoms strongly match disease 1 out of a number of diseases (disease 2, disease 3, and so on). At block 120, the classifier may incorrectly provide the output classification as disease 1. Incorrect classification in the field of medical diagnostics may lead to missing critical diseases during diagnosis and serious consequences for a person's safety. Specifically, the incorrect classification may lead to misdiagnosis resulting in inappropriate treatment plans or delayed interventions, potentially compromising patient health.

FIG. 1D is a diagram illustrating another example use case scenario where the classifier may misclassify input data. In FIG. 1D, the classifier may be provided with an authentication system 122 that provides access to administrators/authorized personnel. When a user 124 tries to go past the authentication system 122, the authentication system 122 checks input data from the user 124, for instance, biometric information, and incorrectly classifies the user 124 as not being an administrator. For instance, the authentication system 122 may have an authentication threshold of 90% and determine a probability of less than 90% (for example, 55%) for the user 124 to be the administrator. Thus, the authentication system 122 may not classify the user 124 to be an administrator and may restrict further access, however, the user 124 may indeed be an authorized user/the administrator.

FIG. 1E is a diagram illustrating another example use case scenario where the classifier may misclassify input data. In FIG. 1E, the classifier may be provided with a face recognition engine 126. However, the classifier may incorrectly classify face of a user 128, which may lead to face recognition failure.

FIG. 1F is a diagram illustrating another example use case scenario where the classifier may misclassify input data. The input data may be historical data, such as data associated with finance, economics, natural disasters, etc. The input data may be provided to the classifier at block 130. At block 132, the classifier may predict various scenarios (scenario 1, scenario 2, and the like) and the predict scenario 1 to be the strongest match. However, the classifier may not predict a strong match for a worst-case scenario. At block 134, the classifier may provide scenario 1 as classification output, missing the worst-case scenario (worst minimum value, worst disaster possible, etc.).

FIG. 1G is a diagram illustrating another example use case scenario where the classifier may misclassify input data. The input data may be speech input from a user 136. The classifier may be provided with a speech recognition engine in a user device 138. The speech input may include the words “search Korean pledge”. The classifier may process the speech input, and regarding the speech input for the word “pledge”, the classifier may classify the speech input to correspond to the word “placed” more strongly rather than the word “pledge”. As a result, incorrect outputs may be provided to the user.

As is evident from the various example use case scenarios, in real-world applications, misclassification can have serious implications, such as misdiagnosis in medical fields, biometric detection failures, face recognition failures, false positives or negatives in fraud detection systems, incorrect identification in autonomous vehicles, incorrect identification of speech, and the like.

Therefore, there is a need to address the above-mentioned problems. For instance, there is a need for systems and methods which provides fault-tolerant predictions during classifications and enhance the reliability in practical applications.

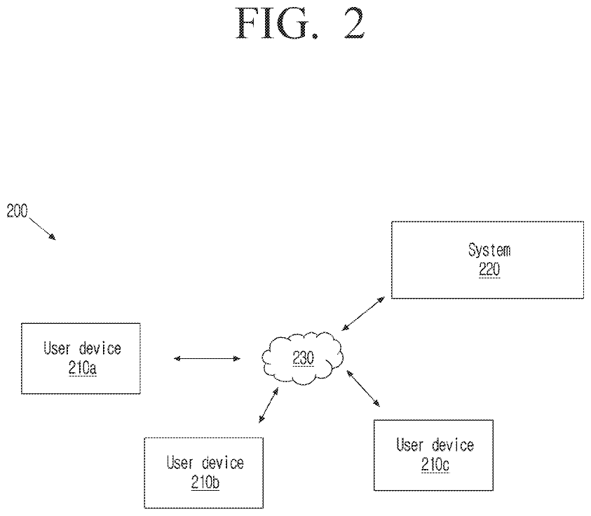

FIG. 2 is a block diagram illustrating an example environment 200 for predicting a set of probable classes for test data according to various embodiments. The environment 200 may comprise a plurality of user devices 210a, 210b, 210c and a system 220 communicatively coupled to the plurality of user devices 210a, 210b, 210c. It is appreciated that details may be provided with respect to a user device (referred to as ‘user device 210’ hereinafter) from among the plurality of user devices 210a, 210b, 210c, and the details are equally applicable for each of the plurality of user devices 210a, 210b, 210c.

In various embodiments, the user device 210 may be associated with a user. In various embodiments, the user device 210 may include any device such as, but not limited to, a smart phone, a laptop, a desktop, a smart watch, a tablet, or a personal digital assistant (PDA) of the user. In various embodiments, the user device 210 may be configured to generate test data. Various non-limiting examples of test data include speech, photos, videos, text, biometric information, and the like. In other words, the test data may refer to data that is to be classified into one or more classes from a plurality of classes. In various embodiments, the test data may be associated with one of a recognition type or a detection type, as will be described further below.

The system 220 may be configured to conformally predict a set of probable classes for the test data. The system 220 may be communicatively coupled to the user device 210 via communication means 230. In various embodiments, the system 220 may be an on-device system, in that, the system 220 may be integrated with the user device 210 and may be configured to predict the set of probable classes in conjunction with the user device 210. In various embodiments, the system 220 may be a cloud-based system. In various embodiments, the system 220 may be provided in a distributed manner, in that, one or more components and/or functionalities of the system 220 may be provided through the user device 210, and one or more components and/or functionalities of the system 220 may be provided through a cloud-based unit, such as, a cloud storage or a cloud-based server.

The communication means 230 may, for example, include a communication network such as, without limitation, a direct interconnection, Local Area Network (LAN), Wide Area Network (WAN), wireless network (e.g., using Wireless Application Protocol (WAP)), the Internet, etc. In various embodiments, the communication means 230 may include internal communication buses and interfaces of the user device 210.

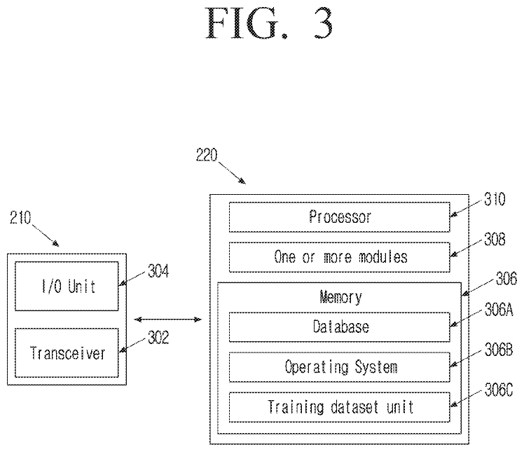

FIG. 3 is a block diagrams illustrating an example configuration of the user device 210 and the system 220 for predicting the set of probable classes for the test data, according to various embodiments.

The user device 210 may comprise a transceiver 302 configured to receive and/or transmit signals from and to the system 220 as well as any other device/unit in connection thereto. The user device 210 may comprise an Input/Output (I/O) unit (e.g., including various input/output circuitry) 304. In various embodiments, the I/O unit 304 may enable the user device 210 to receive and/or generate the test data for which a set of probable classes are to be predicted. The I/O unit 304 may allow input and output to and from the user device 210 using suitable devices such as, but not limited to, a camera, a keyboard, a mouse, a pointer, a sensor, a printer, a microphone, a speaker, and the like. In various embodiments, the I/O unit 304 may provide a display function, such as through a display and/or a Graphical User Interface (GUI), and one or more physical buttons on the user device 210. In various embodiments, the I/O unit 304 may be configured to receive a user input, from a user and/or any external components/device, and facilitate predicting a set of probable classes based on the user input. It is appreciated that although the I/O unit 304 is being depicted as a single entity, the I/O unit 304 is intended to include a plurality of units associated with the user device 210.

In various embodiments, the I/O unit 304 in communication with the transceiver may facilitate communication with the system 220 and may employ communication protocols/standards such as, but not limited to, Code-Division Multiple Access (CDMA), High-Speed Packet Access (HSPA+), Global System for Mobile Communications (GSM), 3rd Generation cellular communication, Long-Term Evolution (LTE), 5th Generation cellular communication, WiMax, WiFi, Bluetooth, Bluetooth low energy (BLE), or the like.

Embodiments are non-limiting examples and the user device 210 may include any additional components such as, but not limited to, processor(s), memory(ies), and the like, which may be required to implement the desired functionality of the user device 210, for example to provide test data. Due to generic nature of said components, the description of said components has been omitted for the sake of brevity.

The system 220 may comprise a memory 306, one or more modules (e.g., including various circuitry and/or executable program instructions) 308, and a processor/controller (e.g., including processing circuitry) 310 (referred to as ‘processor 310’ hereinafter). In various embodiments, the one or more modules 308 may be included within the memory 306. In various embodiments, the memory 306 may be communicatively coupled to the processor 310. The memory 306 may be configured to store data, and instructions executable by the processor 310. The memory 306 may include a database 306A configured to store data.

In various embodiments, the one or more modules 308 may include a set of instructions that may be executed to cause the system 220 to perform any one or more of the methods disclosed herein. The one or more modules 308 may be configured to perform the steps of the present disclosure using the data stored in the database 306A to facilitate prediction of set of probable classes, as discussed throughout this disclosure. In an embodiment, each of the one or more modules 308 may be hardware units that may be outside the memory 306. Further, the memory 306 may include an operating system 306B for performing one or more tasks of the system 220, as performed by a generic operating system in the communications domain.

The memory 306 may include a training dataset unit 306C comprising a training dataset, the training dataset unit 306C being configured to store training data based on which the processor 310, in conjunction with the modules 308, may determine a set of probable classes for the test data. The memory 306 may be operable to store instructions executable by the processor 310. The functions, acts, or tasks illustrated in the figures or described may be performed by the programmed processor/310 for executing the instructions stored in the memory 306. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

For the sake of brevity, the architecture and standard operations of operating system 306B, memory 306, database 306A, and processor 310 are not discussed in detail. In an embodiment, the database 306A may be configured to store the information as required by the one or more modules 308 and processor 310 to perform one or more functions to predict the set of probable classes for the test data.

In various embodiments, the memory 306 may communicate via a bus within the system 220. The memory 306 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In an example, the memory 306 may include a cache or random-access memory for the processor. In alternative examples, the memory 306 is separate from the processor, such as a cache memory of a processor, the system memory, or other memory.

Further, the present disclosure contemplates a computer-readable medium that includes instructions or receives and executes instructions responsive to a propagated signal, so that a device connected to a network may communicate voice, video, audio, images, or any other data over a network. Further, the instructions may be transmitted or received over the network via a communication port or interface or using a bus (not shown). The communication port or interface may be a part of the processor 310 or maybe a separate component. The communication port may be created in software or maybe a physical connection in hardware. The communication port may be configured to connect with a network, external media, the display, or any other components in a system, or combinations thereof. The connection with the network may be a physical connection, such as a wired Ethernet connection, or may be established wirelessly. Likewise, the additional connections with other components of the system 220 may be physical or may be established wirelessly. The network may alternatively be directly connected to the bus.

In an embodiment, the processor 310 may include specialized processing units such as integrated system (bus) controllers, memory management control units, floating point units, graphics processing units, digital signal processing units, etc. In an embodiment, the processor 310 may include a Central Processing Unit (CPU), a Graphics Processing Unit (GPU), or both. The processor 310 may be one or more general processors, digital signal processors, application-specific integrated circuits, field-programmable gate arrays, servers, networks, digital circuits, analog circuits, combinations thereof, or other now-known or later developed devices for analyzing and processing data. In various embodiments, the processor 310 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 310 may implement a software program, such as code generated manually (e.g., programmed). In other words, the processor 310 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In various embodiments, the processor 310 may be disposed in communication with the user device 210 by means of a network interface (not shown). In various embodiments, the network interface may act as an I/O unit, such as I/O unit 304 in a scenario where the system 220 is integrated within the user device 210. The network interface may connect to a communication network, such as, communication means 230. The network interface may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc.

In various embodiments, as described above, the system 220 may be provided in a distributed manner. For instance, the processor 310 and the associated functionalities may be provided through the user device 210, in that, the processor 310 may be integrated within the user device 210. Further, the memory 306 and the associated functionalities may be provided through a cloud-based system.

In various embodiments, the processor may control the processing of input data in accordance with a predefined operating rule or artificial intelligence (AI) model stored in the non-volatile memory and the volatile memory. The predefined operating rule or artificial intelligence model is provided through training or learning.

Here, being provided through learning may refer, for example, to, by applying a learning technique to a plurality of learning data, a predefined operating rule or AI model of a desired characteristic being made. The learning may be performed in a device itself in which AI according to an embodiment is performed, and/or may be implemented through a separate server/system.

The AI model may include a plurality of neural network layers. Each layer may have a plurality of weight values and may perform a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning technique may refer, for example, to a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning.

According to the disclosure, a method for predicting a set of probable classes may use an artificial intelligence model to process test data. The processor may perform a pre-processing operation on the data to convert into a form appropriate for use as an input for the artificial intelligence model. The artificial intelligence model may be obtained by training. Here, “obtained by training” may refer, for example, to a predefined operation rule or artificial intelligence model configured to perform a desired feature (or purpose) being obtained by training a basic artificial intelligence model with multiple pieces of training data by a training technique. The artificial intelligence model may include a plurality of neural network layers. Each of the plurality of neural network layers may include a plurality of weight values and may perform neural network computation by computation between a result of computation by a previous layer and the plurality of weight values.

Reasoning prediction may refer, for example, to a technique of logical reasoning and predicting by determining information and includes, e.g., knowledge-based reasoning, optimization prediction, preference-based planning, or recommendation.

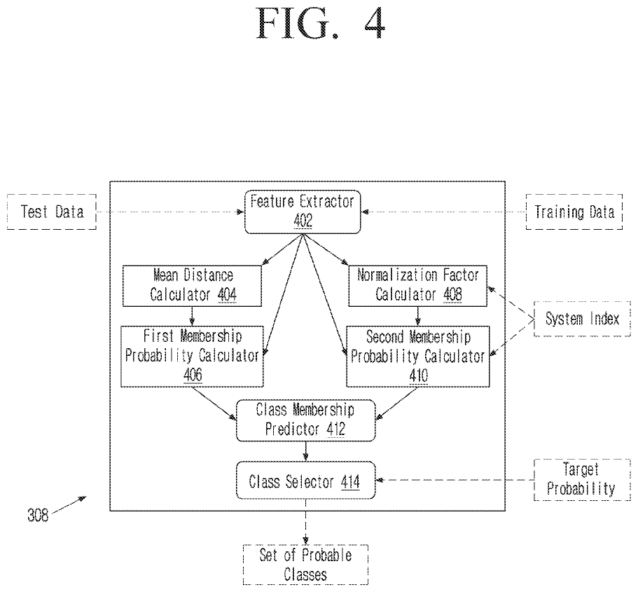

FIG. 4 is a block diagram illustrating an example configuration of the one or more modules 308 of the system 220 for predicting the set of probable classes for the test data according to various embodiments. In an embodiment, the one or more modules 308 may include a feature extractor 402, a mean distance calculator 404, a first membership probability calculator 406, a normalization factor calculator 408, a second membership probability calculator 410, a class membership predictor 412, and a class selector 414, each of which may include various circuitry and/or executable program instructions. Further, one or more modules 308 perform their designated functions in conjunction with the memory 306 and the processor 310. The detailed explanation of each of the modules 308 is discussed in conjunction with FIG. 3 hereinafter.

In various embodiments, the one or more modules 308 may be communicatively coupled with other components of the system 220, such as, the memory 306. The one or more modules 308 may further be coupled to the user device 210. The one or more modules 308 may be configured to receive one or more inputs from the user device 210.

Referring to FIGS. 3 and 4, the processor 310 may be configured to, in conjunction with the feature extractor 402, receive the test data from the user device 210. The processor 310 may further be configured to, in conjunction with the feature extractor 402, extract a test feature vector from the test data. In various embodiments, the test feature vector may be associated with a plurality of features corresponding to the test data. In various embodiments, the test feature vector may be represented by an array of features associated with the test data.

The processor 310 may further be configured to retrieve from the memory 306, in particular from the training dataset unit 306C, a plurality of classes and a plurality of corresponding training feature vectors for each of the plurality of classes. In various embodiments, the plurality of classes may be pre-stored in the training dataset 306C. The processor 310, in conjunction with the feature extractor 402, may be configured to extract, from training data associated with the training data stored in the training dataset unit 306C, the plurality of corresponding training feature vectors for each of the plurality of classes.

As an example, the processor 310 may be configured to, in conjunction with the feature extractor 402, extract a test feature vector t from the test data. Further, the training dataset 306C may have the plurality of classes C₁, C₂, C_{N}. For class C1, the plurality of corresponding training feature vectors {f1₁, f1₂, f1₃, . . . } may be extracted. Further, for class C2, the plurality of corresponding training feature vectors {f2₁, f2₂, f2₃, . . . } may be extracted. Accordingly, for each class Cn (where 1≤n≤N), the plurality of corresponding feature vectors fnᵢ may be extracted by the processor 310 in conjunction with the feature extractor 402.

In various embodiments, considering the one or more modules 308, the feature extractor 402 may receive the test data as an input and retrieve the plurality of classes from the memory 306. Further, the feature extractor 402 may extract the test feature vector t from the test data and the plurality of corresponding training feature vectors fnᵢ from the plurality of classes. Further, the feature extractor 402 may provide the plurality of corresponding training feature vectors fnᵢ to the first membership probability calculator 406. Further, the feature extractor 402 may provide both the test feature vector t and the plurality of corresponding training feature vectors fnᵢ to the mean distance calculator 404, the normalization factor calculator 408, and the second membership probability calculator 410.

The processor 310 may be configured to determine a set of membership probabilities for the test data. The set of membership probabilities comprises a corresponding membership probability associated with each of the plurality of classes. The corresponding membership probability is indicative of a probability of the test data belonging to a corresponding class of the plurality of classes.

Continuing the above example, for each class Cₙ, the corresponding membership probability pₙ may be determined. That is, for class C₁, the corresponding membership probability p₁ may be probability of the test data belonging to the class C₁. As the corresponding membership probability pₙ is determined for each class Cₙ, a set of membership probabilities {p₁, p₂, . . . , pₙ}, interchangeably referred to as {pₙ} hereinafter, is obtained.

The processor 310 may be configured to receive a user input indicative of a type of the test data. The type of the test data may include a recognition type or a detection type. In the recognition type, members of a class are considered as an approximate representation of the characteristics of the class. In the detection type, members of a class are considered as true and complete instances of the class. An example of recognition type may include fingerprint recognition, where each training data is an approximate representation. An example of a detection problem may include detection of all faces in an image, where each training data can be considered to be an independent version of the class.

When the type associated with the test data belongs to the recognition type, the processor 310 may be configured to determine the set of membership probabilities in conjunction with the mean distance calculator 404 and the first membership probability calculator 406.

The processor 310 may be configured to, in conjunction with the mean distance calculator 404, determine a corresponding mean vector for each of the plurality of classes based on the plurality of corresponding training feature vectors. Further, the processor 310 may be configured to, in conjunction with the mean distance calculator 404, determine a distance vector for each of the plurality of classes based on the corresponding mean vector and the test feature vector.

In various embodiments, the processor 310 may be configured to select a class from the plurality of classes, and for the selected class, perform first processing steps that include accessing the plurality of corresponding training feature vectors for the selected class, determining the corresponding mean vector for the selected class, and determining the corresponding distance vector for the selected class. The processor 310 may be configured to repeat the first processing steps for each selected class from among the plurality of classes.

Continuing with the above example, for each class Cₙ, a corresponding mean vector uₙ may be determined. Further, for each class Cₙ, a corresponding distance vector dₙ may be determined. That is, for class C₁, mean vector u₁ and distance vector d₁ may be determined, for class C₂, mean vector u₂ and distance vector d₂ may be determined, and so on.

In various embodiments, the mean vector uₙ may be determined based on the equation (1):

$${u}_{n} = \frac{{\sum }_{i} {fn}_{i}}{{\sum }_{i} 1} \qquad ( 1 )$$

In various embodiments, the distance vector dₙ may be determined based on the equation (2):

$${d}_{n} = t - {u}_{n} \qquad ( 2 )$$

In various embodiments, considering the one or more modules 308, the mean distance calculator 404 may receive the test feature vector t and plurality of corresponding training feature vectors fnᵢ as inputs from the feature extractor 402. Further, the mean distance calculator 404 may determine and output the corresponding mean vectors uₙ and the corresponding distance vectors dₙ to the first membership probability calculator 406.

The processor 310 may be configured to select a class from the plurality of classes and perform, in conjunction with the first membership probability calculator 406, second processing steps for the selected class. In the second processing steps, the processor 310 may be configured to determine difference parameters for each of the plurality of corresponding feature vectors of the selected class. As a result, a set of difference parameters associated with the selected class is obtained.

Further, in the second processing steps, the processor 310 may be configured to determine a standard deviation associated with the selected class based on the set of difference parameters. Further, in the second processing steps, the processor 310 may be configured to determine a distribution of the plurality of corresponding training feature vectors with respect to the corresponding mean vector. In various embodiments, a normal distribution may be determined by the processor 310.

Further, in the second processing steps, the processor 310 may be configured to select a probability density function associated with the determined distribution. Further, in the second processing steps, the processor 310 may be configured to determine the corresponding membership probability of the test feature vector for the selected class based on the probability density function, a magnitude of the corresponding distance vector, and the determined standard deviation. The processor 310 may be configured to repeat the second processing steps in conjunction with the first membership probability calculator 406 for each selected class from among the plurality of classes.

Once the corresponding membership probability of the test feature vector is determined for each of the plurality of classes, the set of membership probabilities of the test feature vector may be determined by the processor 310. The set of membership probabilities may indicate the probability of the test data belonging to the plurality of classes, e.g., probability of the test data belonging to a first class, probability of the test data belonging to a second class, and so on.

Continuing with the above example, the plurality of training feature vectors fnᵢ may be accessed for each class Cₙ. Further, a corresponding difference parameter enᵢ for each of the plurality of training feature vectors fnᵢ may be calculated. The difference parameter enᵢ may be indicative of a difference of the corresponding training feature vector from the mean vector u₂ as projected along the distance vector dₙ. That is, for class C₂, the difference parameter e2ᵢ may be indicative of a difference of the corresponding training feature vector f2ᵢ from the mean vector u₂ as projected along the distance vector d₂. In various embodiments, the corresponding difference parameter enᵢ may be determined based on the equation (3):

$${en}_{i} = ( {fn}_{i} - {u}_{n} ) \cdot {d}_{n} \qquad ( 3 )$$

Further, as the corresponding difference parameter enᵢ is calculated for each of the plurality of corresponding training feature vectors fnᵢ associated with the class Cₙ, a set of values of difference parameter enᵢ may be obtained for the class Cₙ.

Further, the standard deviation σₙ may be calculated from the set of values of difference parameter enᵢ. For the class Cₙ, the standard deviation of the associated training data as projected along the corresponding distance vector dₙ may thus be obtained.

Further, for each class Cₙ, the corresponding membership probability pₙ may be determined based on the probability density function of the determined distribution, the standard deviation σₙ for the class Cₙ, and a magnitude of the distance vector |dₙ| for the class Cₙ. In various embodiments, if the probability density function is represented as fx, then the corresponding membership probability pₙ for each class Cₙ may be given by the equation (4) as shown below:

$${p}_{n = 2} {\int }_{\frac{\vert {d}_{n} \vert}{{σ}_{n}}}^{∞} {f}_{X} ( t ) dt$$

As the corresponding membership probability pₙ is determined for each class Cₙ, the set of membership probabilities {p₁, p₂, . . . , pₙ} is thus obtained.

In various embodiments, considering the one or more modules 308, the first membership probability calculator 406 may receive the distance vector dₙ and mean vector uₙ as inputs from the mean distance calculator 404 and the plurality of corresponding training feature vectors fnᵢ as inputs from the feature extractor 402. Further, the first membership probability calculator 406 may determine and output the set of membership probabilities {p₁, p₂, . . . , pₙ} to the class membership predictor 412.

When the type associated with the test data is detection type, the processor 310 may be configured to determine the set of membership probabilities in conjunction with the normalization factor calculator 408 and the second membership probability calculator 410.

The processor 310 may be configured to, in conjunction with the normalization factor calculator 408, receive the plurality of corresponding training feature vectors and the test feature vector from the feature extractor 402. The processor 310 may further be configured to receive from the user device 210, a user input indicative of a system index. The system index may be indicative of the sensitivity of a learned model to outliers, e.g., data that is away from a mean value. In various embodiments, a larger system index implies that the outliers are given less weight in building the learned model, whereas a smaller index implies that the outlier are given relatively more weight in building the learned model.

The processor 310 may be configured to, in conjunction with the normalization factor calculator 408, determine a normalization factor based on the received system index and the plurality of the corresponding training feature vectors for each of the plurality of classes.

Continuing with the above example, the plurality of corresponding training feature vectors fnᵢ for each class Cₙ, the test feature vector t, and the system index a is obtained by the normalization factor calculator 408. Further, the normalization factor b is calculated by the normalization factor calculator 408 and provided as output to the second membership probability calculator 410. In various embodiments, the normalization factor b may be determined based on the equation (5):

$$b ( \frac{1}{{\vert f {1}_{1} - t \vert}^{a}} + \frac{1}{{\vert f {1}_{2} - t \vert}^{a}} + … + \frac{1}{{\vert f {2}_{1} - t \vert}^{a}} + \frac{1}{{\vert f {2}_{2} - t \vert}^{a}} + … ) = 1 ( 1 ) \qquad ( 5 )$$

The processor 310 may be configured to, in conjunction with the second membership probability calculator 410, determine the set of membership probabilities. In various embodiments, the processor 310 may be configured to select a class from among the plurality of classes and for each selected class, perform third processing steps. In the third processing steps, the processor 310 may be configured to determine the corresponding membership probability for the selected class based on the normalization factor, the test feature vector, the system index, and the plurality of corresponding training feature vectors of the selected class.

In the third processing steps, the processor 310 may be configured to determine the set of membership probabilities based on the determined corresponding membership probability for each selected class of the plurality of classes. The processor 310 may be configured to repeat the third processing steps in conjunction with the second membership probability calculator 410 for each selected class from among the plurality of classes.

Continuing with the above example, the second membership probability calculator 410 may obtain the normalization factor b from the normalization factor calculator 408, the system index a from the user device 210, and the plurality of corresponding training feature vectors fnᵢ for each class Cₙ and the test feature vector t from the feature extractor 402.

For each class Cₙ, the membership probability pₙ may be determined based on the equation (6):

$${p}_{n =} b {\sum }_{i} \frac{1}{{\vert {fn}_{i} - t \vert}^{a}} \qquad ( 6 )$$

Once the membership probability pₙ is determined for each class Cₙ, the set of membership probabilities {p₁, p₂, . . . , pₙ} may thus be obtained. The set of membership probabilities {p₁, p₂, . . . , pₙ} may be provided as output to the class membership predictor 412.

The processor 310 may be configured to, in conjunction with the class membership predictor 412, receive the set of membership probabilities from the first membership probability calculator 406 in case the test data may be associated with recognition type and from the second membership probability calculator 410 in case the test data may be associated with detection type. The processor 310 may further to configured to sort the set of membership probabilities to determine a sorted probability array. In various embodiments, the sorted probability array may include the set of membership probabilities, e.g., the corresponding membership probabilities for each class of the plurality of classes, sorted based on the values of the corresponding membership probabilities. In various embodiments, the sorting may be in descending order such that the corresponding membership probability having the highest value is followed by the corresponding membership probabilities having decreasing values.

Continuing with the above example, the processor 310 may be configured to sort the set of membership probabilities {p₁, p₂, . . . , pₙ} to determine the sorted probability array p. For each of the plurality of classes Cₙ, the sorted array p may include the set of membership probabilities {p₁, p₂, . . . , pₙ} sorted from high to low. For instance, the sorted array p may include {p₃, p₁, p₂, . . . } associated with classes {C₃, C₁, C₂, . . . } where the values of p₃>p₁>p₂. The sorted array p indicates that the test data has the highest probability of belonging to class C₃, the next highest probability of belonging to class C₃, and so on, based on the values of the corresponding membership probabilities {p₃, p₁, p₂, . . . } which form the set of membership probabilities {p₁, p₂, . . . , pₙ} The sorted array p may be provided as output to the class selector 414.

In various embodiments, considering the one or more modules 308, the class membership predictor 412 may receive the set of membership probabilities {p₁, p₂, . . . , pₙ} from the first membership probability calculator 406 (in case of recognition type) or the second membership probability calculator 410 (in case of detection type), and further, may determine and output the sorted array p to the class selector 414.

The processor 310 may be configured to, in conjunction with the class selector 414, receive a user input from the user device 210, the user input being indicative of a target probability required for the test data. The target probability may indicate a desired probability, or a minimum probability guarantee, of the test data falling into one or more classes of the plurality of classes.

The processor 310 may be configured to, in conjunction with the class selector 414, determine the set of probable classes from among the plurality of classes. In various embodiments, the processor 310 may be configured to select the set of probable classes based on the sorted probability array and the target probability received via the user input. The set of probable classes may be selected such that a combined probability of the set of probable classes is greater than the target probability.

Continuing with the above example, the processor 310 may be configured to select a number of probable classes C[1], . . . C[k] from among the plurality of classes Cₙ based on the sorted probability array p and the target probability r. The sorted probability array P comprises the sorted set of membership probabilities {pₙ}. The processor 310, in conjunction with the class selector 414, may select highest k probabilities from the sorted array p such that a combined probability of the selected highest k probabilities is greater than the target probability r. Once the k highest probabilities are selected, the classes associated with the k highest probabilities, e.g., C[1], . . . C[k] are determined as the set of probable classes. For instance, assuming the sorted array P={p₃, p₁, p₂, . . . } includes a sorted set of membership probabilities associated with classes {C₃, C₁, C₂, . . . }. A combined probability of the membership . . . probabilities p₃+p₁ may be greater than a target probability r. As a result, the classes C₃,C₁ associated with the corresponding membership probabilities p₃,p₁ form the set of probable classes C[1],C[2]=C₃,C₁;k=2 Similarly, in case the combined probability of membership probabilities p₃+p₁+p₂ is greater than target probability r, then the classes C₃,C₁,C₂ associated with the corresponding membership probabilities p₃,p₁,p₂ form the combined probability of determined as the set of probable classes C[1],C[2],C[3]=C₃,C₁,C₂;k=3

In various embodiments, the highest k probabilities from the sorted array P may be selected based on the equation (7):

$${\sum }_{j = 1}^{k} P [ j ] > r \qquad ( 7 )$$

In other words, a minimum number of probabilities that can be combined to give a combined probability greater than the target probability is selected. In various embodiments, the k probabilities from the sorted array P may be selected as membership probabilities having a combined probability greater than the target probability by a minimum possible value.

The processor 310 may be configured to output the set of probable classes C[1], . . . C[k] along with the corresponding membership probabilities of the set of probable classes, to the user device 210. In various embodiments, the output may be a visual output or an audio-visual output. In various embodiments, the output may be provided through an Application Programming Interface (API) for use in one or more additional user devices.

In various embodiments, the set of probable classes C[1], . . . C[k] along with the corresponding membership probabilities of the set of probable classes may be displayed on a user interface associated with the user device 210, such as, via the display of the user device 210. The user may thus be able to view the probabilities of the test data belonging to different classes such that the combination of the probabilities is greater than a minimum desired probability of the user. For instance, if the user desires a probability of 90%, instead of merely selecting a class with the highest probability, the set of classes is provided that has a total combined probability greater than 90%. Accordingly, rather than misclassification, conformal prediction may be provided, and the output set of classes are always guaranteed to have a high probability of success chosen by the user.

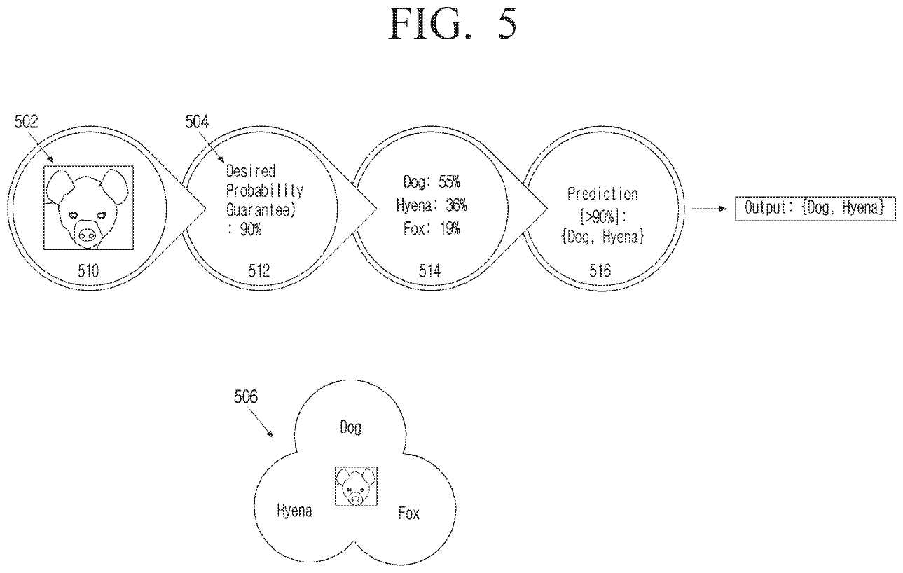

FIG. 5 is a diagram illustrating an example use case for predicting the set of probable classes by the system 220, according to various embodiments. As seen in FIG. 5, a test image 502 of a hyena may be received by the system 220, at block 510. The system 220 may further receive, at block 512, a user input 504 indicative of the target probability, e.g., a desired probability guarantee by the user. For instance, the target probability may be 90%. The system 220 may access training data 506 which may include dog training data, hyena training data, and fox training data. The test image 502 may be such that the test image overlaps with different training data. At block 514, the system 220 may predict the test image 502 to belong to various classes with corresponding probabilities. For instance, the system 220 may determine that the test image belongs to ‘Dog’ class with a probability of 55%, to ‘Hyena’ class with a probability of 36%, and to ‘Fox’ class with a probability of 19%. At block 516, the system 220 may determine the set of probable classes to be {Dog, Hyena} since the combined probability of the set of probable classes (55% and 36%) is greater than the target probability (90%). Accordingly, the system 220 may output the set of probable classes {Dog, Hyena} to the user.

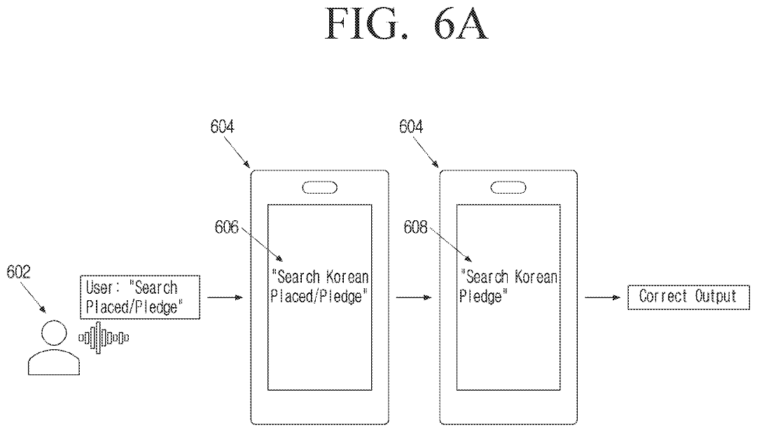

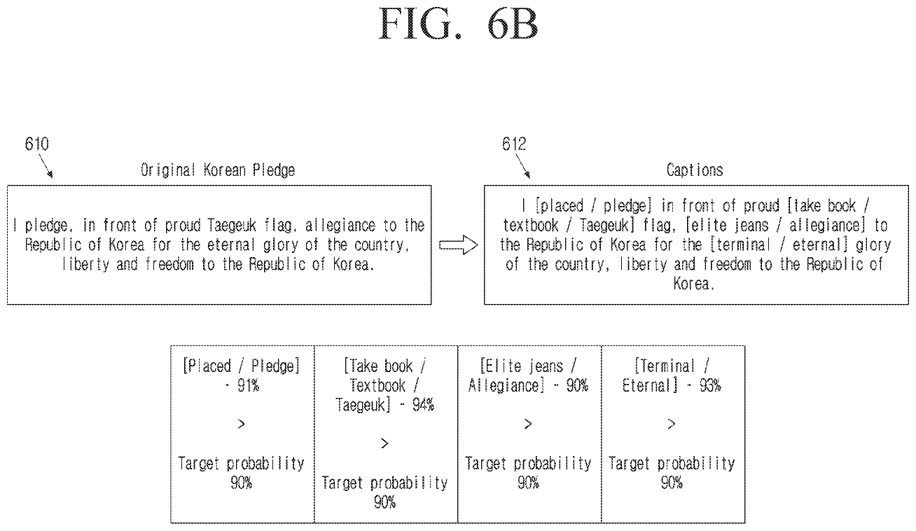

FIG. 6A is a diagram illustrating an example use case for predicting the set of probable classes by the system 220, according to various embodiments. Speech data from a user 602 may be provided as input to the system 220, integrated with a user device 604. The speech data may include the words “search Korean pledge”. The system 220 may process the speech data, and regarding the speech data for the word “pledge”, the system 220 may classify the speech data to correspond to the both words “placed” and “pledge” with respective probabilities. The system 220 may cause the user device 604 to display the set of probable classes, in this case, “placed” and “pledge”, as shown by arrow 606. The user 602 may thus be enabled to select the correct option from the set of probable classes, in this case, “pledge”, as shown by arrow 608. Accordingly, a correct output may be provided to the associated user 602. Speech-to-text applications may thus be made more reliable. The user 602 can thus quickly select the relevant word from the available options, which results in avoiding deletion and re-speaking. Moreover, an increased adoption of voice-based speech-to-text typing in devices would be facilitated.

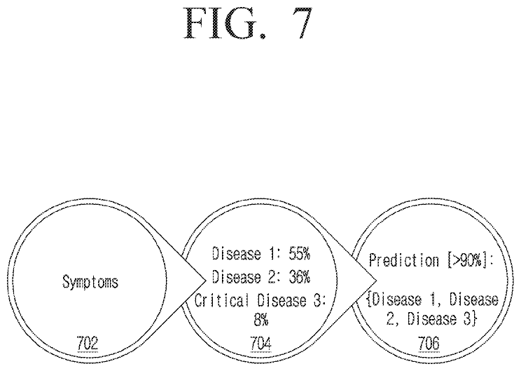

FIG. 6B is a diagram illustrating an example use case for predicting the set of probable classes by the system 220, according to various embodiments. Audio or video data may be provided as input to the system 220, and the system 220 may process the input to generate captions. For instance, the original Korean pledge 610 may be provided as input to the system 220. The system 220 may process the audio and determine a set of probable classes for the terms that are not identified clearly. The system 220 may display the set of probable classes for the unclear terms on a display so as to enable a user to select the appropriate options from the set of probable classes. For instance, the captions 612 may be generated by the system 220. As seen in FIG. 7, the input term “pledge” has been processed by the system 220 and a set of probable classes {placed, pledge} is provided for the user to select the relevant option. The system 220 may be a target probability as 90% and a combined probability of the set of probable classes {placed, pledge} as determined by the system 220, say 91%, may be greater than the target probability, thus, the set of probable classes {placed, pledge} is provided for the user to select the relevant option. Similarly, for the input term “Taegeuk,” the set of probable classes {take book, textbook, Taegeuk} is provided, for the input term “allegiance,” the set of probable classes {elite jeans, allegiance} is provided, for the input term “eternal,” the set of probable classes {terminal, eternal} is provided for the user to select the appropriate option. As a result, the user may mentally choose the correct word to read based on sound and context. Moreover, hearing challenged user can mentally choose the correct word to read based on context.

FIG. 7 is a diagram illustrating an example use case for predicting the set of probable classes by the system 220, according to various embodiments. As seen in FIG. 7, symptoms for a disease may be provided as input data to the system 220, at block 702. At block 704, the system 220 may process the input data and determine multiple classes with respective membership probabilities. For example, the system 220 may determine probability of the input data (symptoms) belonging to each class (disease). For instance, the system 220 may determine that the probability of the symptoms matching disease 1 is 55%, the probability of the symptoms matching disease 2 is 36%, and the probability of the symptoms matching disease 3 is 8%. At block 706, the system 220 may receive a user input indicative of a target probability to be 90%. Further, the system 220 may determine that set of probable classes to be {disease 1, disease 2, disease 3} since the combined probability of the set of probable classes is greater than the target probability. The set of probable classes may be displayed on a user interface to allow a user to view the diseases which may be associated with the symptoms. As a result, a critical disease, such as disease 3, is not missed and the risk of the symptoms being associated with critical disease 3 is identified. Accordingly, in medical diagnosis, missing critical disease detection is eliminated.

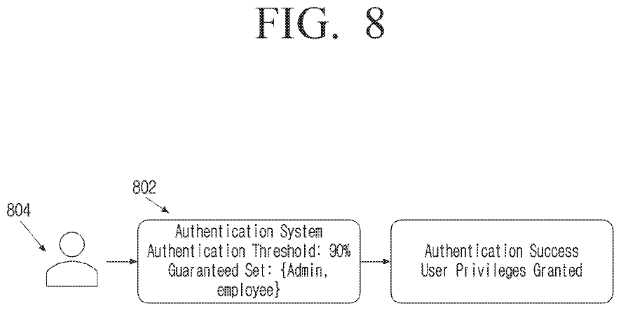

FIG. 8 is a diagram illustrating an example use case for predicting the set of probable classes by the system 220, according to various embodiments. The system 220 may be integrated with an authentication system 802. When a user 804 tries to go past the authentication system 802, the authentication system 802 checks input data from the user 804, for instance, biometrics. The system 220 may have a threshold of 90% which is required for successful access. The system 220 may process the input data from the user 804 to determine a set of probable classes for the user 804 to be {admin, employee}. As the combined probability of the set of probable classes is greater than the threshold of 90%, access and privileges are granted. Accordingly, there is less rate of authentication failure, and in some cases, the lowest privileges may be granted rather than completely denying access.

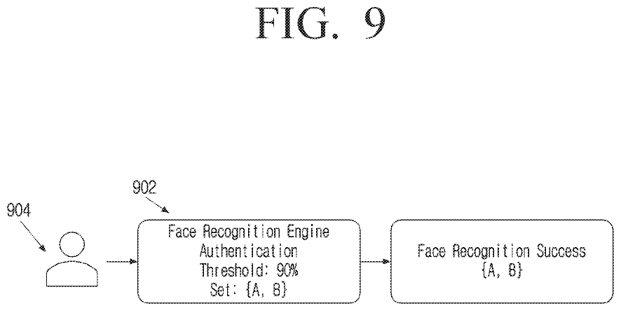

FIG. 9 is a diagram illustrating an example use case for predicting the set of probable classes by the system 220, according to various embodiments. The system 220 may be integrated with a face recognition engine 902. The system 220 may process facial features as inputs from the user 904 and determine a set of probable classes that match the facial features. For instance, the system 220 may have a threshold of 90%, and the system 220 may determine that the user 904 may be one of a set of users {A, B} since a combined probability of the set of users may be greater than the threshold. As a result, facial recognition may be a success and there are fewer chances of facial recognition failures.

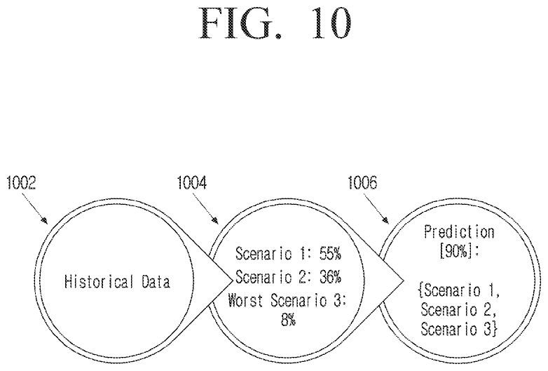

FIG. 10 is a diagram illustrating an example use case for predicting the set of probable classes by the system 220, according to various embodiments. The system 220 may receive input data at block 1002. The input data may be historical data, such as, data associated with finance, economics, natural disasters, etc. At block 1004, the system 220 may predict the probabilities associated with multiple scenarios, such as, scenario 1 having probability of 55%, scenario 2 having probability of 36%, and scenario 3 having probability of 8%. At block 1006, the system 220 may determine the set of probable classes based on a prediction threshold, for instance 90%. The system 220 may predict the set of probable classes to comprise {scenario 1, scenario 2, scenario 3}. As a result, a worst-case scenario, such as scenario 3 is not missed, rather, the scenario is identified as one of the scenarios in the set of probable classes. Accordingly, there is no risk of missing identification of worst-case scenarios such as worst minimum value, worst disaster possible, etc.

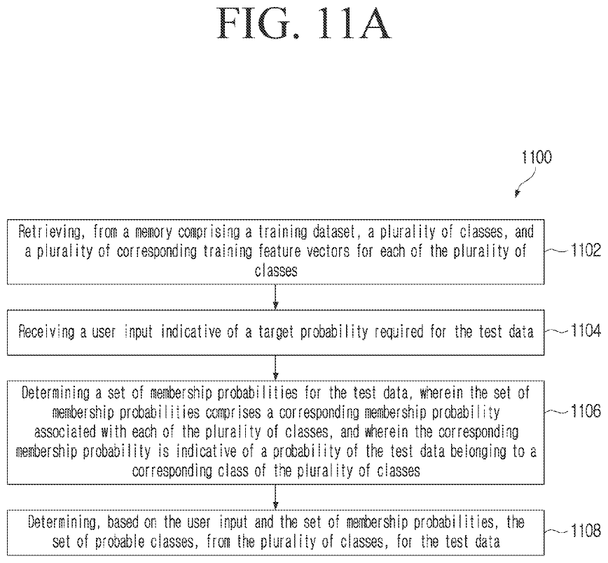

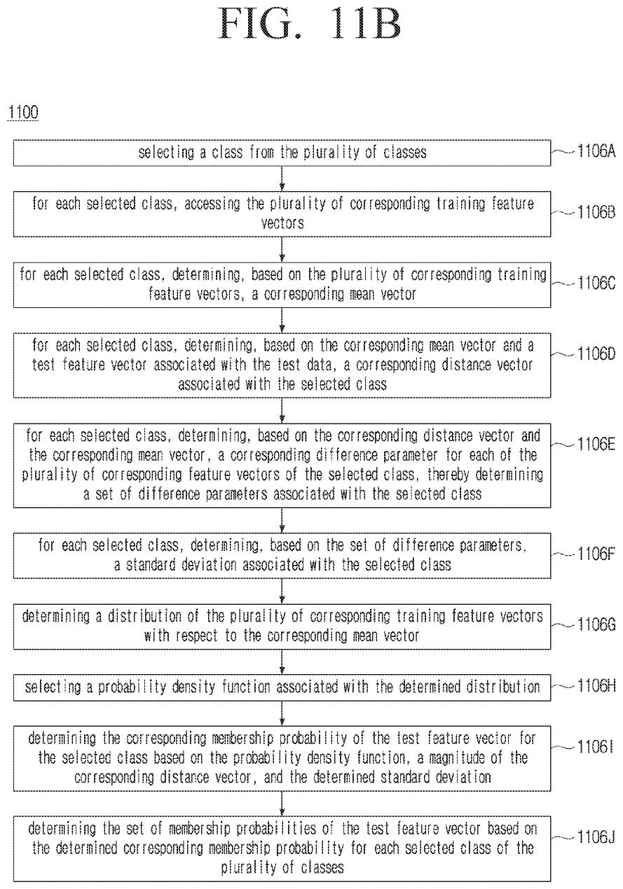

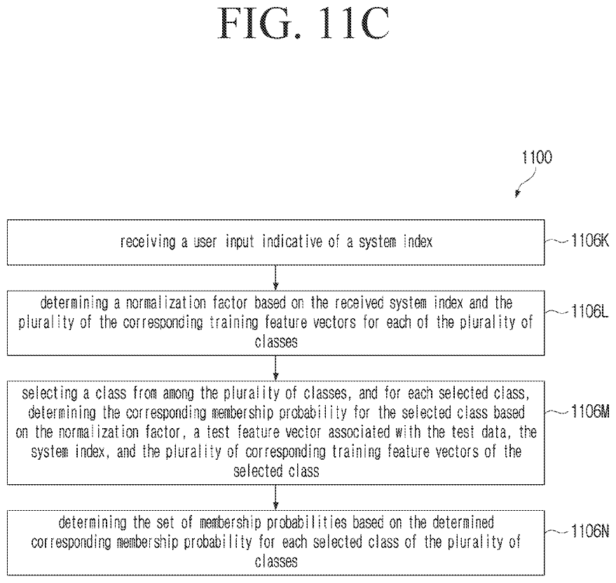

Reference is made to FIG. 11A which is a flowchart illustrating an example method 1100 for predicting a set of probable classes for test data, according to various embodiments. In an embodiment, the steps or operations of the method 1100 may be performed by the system 220, as discussed above.

At 1102, the method 1100 comprises retrieving, from the memory comprising the training dataset unit, a plurality of classes, and a plurality of corresponding training feature vectors for each of the plurality of classes.

At 1104, the method 1100 comprises receiving an input, e.g., a user input, indicative of a target probability required for the test data.

At 1106, the method 1100 comprises determining a set of membership probabilities for the test data. The set of membership probabilities comprises a corresponding membership probability associated with each of the plurality of classes. The corresponding membership probability is indicative of the probability of the test data belonging to a corresponding class of the plurality of classes.

At 1108, the method 1100 comprises determining, based on the user input and the set of membership probabilities, the set of probable classes, from the plurality of classes, for the test data.

In various embodiments, the user input may be indicative of a type associated with the test data. The type may be one of a recognition type or a detection type.

In various embodiments, when the type associated with the test data is recognition type, the method 1100 may comprise sub-steps 1106A-1106J to determine the set of membership probabilities for the test data, as illustrated in greater detail below with reference to FIG. 11B.

At 1106A, the method 1100 comprises selecting a class from the plurality of classes. At 1106B, the method 1100 comprises, for each selected class, accessing the plurality of corresponding training feature vectors.

At 1106C, the method 1100 comprises determining, based on the plurality of corresponding training feature vectors, a corresponding mean vector. At 1106D, the method 1100 comprises determining, based on the corresponding mean vector and a test feature vector associated with the test data, a corresponding distance vector associated with the selected class.

At 1106E, the method 1100 comprises determining, based on the corresponding distance vector and the corresponding mean vector, a corresponding difference parameter for each of the plurality of corresponding feature vectors of the selected class, thereby determining a set of difference parameters associated with the selected class.

At 1106F, the method 1100 comprises determining, based on the set of difference parameters, a standard deviation associated with the selected class. At 1106G, the method 1100 comprises determining a distribution of the plurality of corresponding training feature vectors with respect to the corresponding mean vector.

At 1106H, the method 1100 comprises selecting a probability density function associated with the determined distribution. At 1106I, the method 1100 comprises determining the corresponding membership probability of the test feature vector for the selected class based on the probability density function, the magnitude of the corresponding distance vector, and the determined standard deviation.

At 1106J, the method 1100 comprises determining the set of membership probabilities of the test feature vector based on the determined corresponding membership probability for each selected class of the plurality of classes.

In various embodiments, when the type associated with the test data is detection type, the method 1100 may comprise sub-steps 1106K-1106N to determine the set of membership probabilities for the test data, as illustrated in greater detail below with reference to FIG. 11C.

At 1106K, the method 1100 comprises receiving a user input indicative of a system index. At 1106L, the method 1100 comprises determining a normalization factor based on the received system index and the plurality of the corresponding training feature vectors for each of the plurality of classes.

At 1106M, the method 1100 comprises selecting a class from among the plurality of classes, and for each selected class, determining the corresponding membership probability for the selected class based on the normalization factor, a test feature vector associated with the test data, the system index, and the plurality of corresponding training feature vectors of the selected class.

At 1106N, the method 1100 comprises determining the set of membership probabilities based on the determined corresponding membership probability for each selected class of the plurality of classes.

In various embodiments, the method 1100 may further comprise extracting, from the test data, the test feature vector. The test feature vector is associated with a plurality of features corresponding to the test data. In various embodiments, the method 1100 may further comprise extracting, from training data associated with the training data stored in the training dataset unit 306C, the plurality of corresponding training feature vectors for the plurality of classes.

In various embodiments, the method 1100 may further comprise sorting the set of membership probabilities to form a sorted probability array. In various embodiments, the method 1100 may further comprise selecting the set of probable classes based on the sorted probability array and the target probability. The combined probability of the set of probable classes is greater than the target probability.

In various embodiments, the method 1100 may further comprise providing, via a user device, an output indicating the set of probable classes.

While the above-discussed operations of FIGS. 11A, 11B and 11C are shown and described in a particular sequence, the steps may occur in variations to the sequence in accordance with various embodiments. Further, a detailed description related to the various steps of FIGS. 11A, 11B and 11C is already covered in the description related to FIGS. 2-4 and may not be repeated here for the sake of brevity.

The present disclosure provides for various technical advancements based on the key features discussed above. The present disclosure provides methods and systems that guarantee a probability of prediction of classes in a fault tolerant (e.g., fail safe) manner. There is no risk of misclassification as the systems and methods disclosed herein provide fault tolerant classification to conformally predict a set of probable classes for test data taking into account a minimum probability guarantee desired by the user.

Further, a failure in classification may not result in incorrect classification, rather, the systems and methods provide a more general output set of classes. The output set of classes are always guaranteed to have a high probability of success as the probability is based on a target probability provided by the user. Further, the efficiency is increased as failed classification is eliminated, e.g., classes which are not part of the output set of classes can be excluded with a high degree of confidence.

The present disclosure provides me “hods’and systems that are highly beneficial in multiple applications, as depicted with reference to the use cases in FIGS. 5, 6A, 6B, 7, 8, 9 and 10. The present disclosure provides methods and systems that are highly beneficial in high-risk settings, particularly in areas where cost of incorrect classification is high. For instance, there is significantly reduced risk of any errors in prediction in the fields of medical diagnostics and security. In the field of speech-to-text processing, multiple predictions may be provided instead of an incorrect prediction, which enables the user to select the relevant option. In the field of authentication, rather than a failed authentication, minimum privileges may be provided, and access may be allowed.

While specific language has been used to describe the present disclosure, any limitations arising on account thereto, are not intended. As would be apparent to one skilled in the art, various modifications may be made in order to implement the disclosure as taught herein. The drawings and the foregoing description give examples of various embodiments. Those skilled in the art will appreciate that one or more of the described elements may well be combined into a single functional element.

Alternatively, certain elements may be split into multiple functional elements. It will also be understood that any of the embodiment(s) described herein may be used in conjunction with any other embodiment(s) described herein.

What is claimed is:

1. A method for predicting a set of probable classes for test data, the method comprising:
retrieving, from a memory comprising a training dataset, a plurality of classes, and a plurality of corresponding training feature vectors for each of the plurality of classes;
receiving an input indicative of a target probability required for the test data;
determining a set of membership probabilities for the test data, wherein the set of membership probabilities comprises a corresponding membership probability associated with each of the plurality of classes, and wherein the corresponding membership probability is indicative of a probability of the test data belonging to a corresponding class of the plurality of classes; and
determining, based on the input and the set of membership probabilities, the set of probable classes, from the plurality of classes, for the test data.

2. The method as claimed in claim 1, comprising:
receiving an input indicative of a type associated with the test data, the type being one of a recognition type or a detection type.

3. The method as claimed in claim 2, wherein, based on the type associated with the test data being the recognition type, determining the set of membership probabilities for the test data comprises:
selecting a class from the plurality of classes and for each selected class:
accessing the plurality of corresponding training feature vectors;
determining, based on the plurality of corresponding training feature vectors, a corresponding mean vector; and
determining, based on the corresponding mean vector and a test feature vector associated with the test data, a corresponding distance vector associated with the selected class.

4. The method as claimed in claim 3, comprising, for each selected class:
determining, based on the corresponding distance vector and the corresponding mean vector, a corresponding difference parameter for each of the plurality of corresponding feature vectors of the selected class, to determine a set of difference parameters associated with the selected class; and
determining, based on the set of difference parameters, a standard deviation associated with the selected class.

5. The method as claimed in claim 4, comprising:
determining a distribution of the plurality of corresponding training feature vectors with respect to the corresponding mean vector;
selecting a probability density function associated with the determined distribution;
determining the corresponding membership probability of the test feature vector for the selected class based on the probability density function, a magnitude of the corresponding distance vector, and the determined standard deviation; and
determining the set of membership probabilities of the test feature vector based on the determined corresponding membership probability for each selected class of the plurality of classes.

6. The method as claimed in claim 3, comprising:
extracting, from the test data, the test feature vector, wherein the test feature vector is associated with a plurality of features corresponding to the test data; and
extracting, from training data associated with the training dataset, the plurality of corresponding training feature vectors for the plurality of classes.

7. The method as claimed in claim 2, wherein, based on the type associated with the test data being the detection type, determining the set of membership probabilities for the test data comprises:
receiving an input indicative of a system index; and
determining a normalization factor based on the received system index and the plurality of the corresponding training feature vectors for each of the plurality of classes.

8. The method as claimed in claim 7, comprising:
selecting a class from among the plurality of classes;
for each selected class, determining the corresponding membership probability for the selected class based on the normalization factor, a test feature vector associated with the test data, the system index, and the plurality of corresponding training feature vectors of the selected class; and
determining the set of membership probabilities based on the determined corresponding membership probability for each selected class of the plurality of classes.

9. The method as claimed in claim 8, comprising:
extracting, from the test data, the test feature vector, wherein the test feature vector is associated with a plurality of features corresponding to the test data; and
extracting, from training data associated with the training dataset, the plurality of corresponding training feature vectors for the plurality of classes.

10. The method as claimed in claim 1, wherein determining the set of probable classes comprises:
sorting the set of membership probabilities to form a sorted probability array; and
selecting the set of probable classes based on the sorted probability array and the target probability, wherein a combined probability of the set of probable classes is greater than the target probability.

11. The method as claimed in claim 1, comprising:
providing, via a user device, an output indicating the set of probable classes,
wherein the output is one of a visual output or an audio-visual output.

12. A system configured to predict a set of probable classes for test data, the system comprising:
a memory; and
at least one processor, comprising processing circuitry, communicatively coupled to the memory, at least one processor, individually and/or collectively, configured to:
retrieve, from the memory a training dataset, a plurality of classes, and a plurality of corresponding training feature vectors for each of the plurality of classes;
receive an input indicative of a target probability required for the test data;
determine a set of membership probabilities for the test data, wherein the set of membership probabilities comprises a corresponding membership probability associated with each of the plurality of classes, and wherein the corresponding membership probability is indicative of a probability of the test data belonging to a corresponding class of the plurality of classes; and
determine, based on the input and the set of membership probabilities, the set of probable classes, from the plurality of classes, for the test data.

13. The system as claimed in claim 12, wherein at least one processor, individually and/or collectively, is configured to:
receive an input indicative of a type associated with the test data, the type being one of a recognition type or a detection type.

14. The system as claimed in claim 13, wherein, based on the type associated with the test data being the recognition type, to determine the set of membership probabilities for the test data, at least one processor, individually and/or collectively, is configured to:
select a class from the plurality of classes and for each selected class:
access the plurality of corresponding training feature vectors;
determine, based on the plurality of corresponding training feature vectors, a corresponding mean vector; and
determine, based on the corresponding mean vector and a test feature vector associated with the test data, a corresponding distance vector associated with the selected class.

15. The system as claimed in claim 14, wherein at least one processor, individually and/or collectively, is configured to, for each selected class:
determine, based on the corresponding distance vector and the corresponding mean vector, a corresponding difference parameter for each of the plurality of corresponding feature vectors of the selected class, to determine a set of difference parameters associated with the selected class; and
determine, based on the set of difference parameters, a standard deviation associated with the selected class.
